(19) United States
(12) Patent Application Publication
(10) Pub. No.: US 2001/0033705 A1
(43) Pub. Date: Oct. 25, 2001

(54) Motor with compound bearing for OA device

(75) Inventor: Rikuro Obara, Nagano-ken (JP)

Correspondence Address: ISRAEL GOPSTEIN, Esq., 14301 Layhill Rd., Suite 200C, P.O. Box 9303, Silver Spring, MD, 20916-9303, US

(73) Assignee: MINEBEA KABUSHIKI-KAISHA

(21) Appl. No.: 09/804,297

(22) Filed: Mar. 13, 2001

(30) Foreign Application Priority Data
Apr. 19, 2000 (JP) 2000-117815

(51) Int. Cl. F16C 33/60

(52) U.S. Cl. 384/504

(57) ABSTRACT

The object of the present invention is to provide a motor, or spindle motor in which only an assembling operation of a completed compound bearing with the motor may be effected on the side of motor maker, the number of steps required for assembling can be reduced because the assembling operation of the bearing is not necessary, the precision of the rotation of the motor is high, the cost for fabrication can be reduced, the resistance against impact and/or resonance is high since the diameter of the shaft can be enlarged.

A motor with a compound bearing for OA device having a spindle shaft (5) assembled within a sleeve of the bearing apparatus through balls (13, 14), the bearing comprising; the spindle shaft formed of a stepped shaft including a reduced diameter portion and a larger diameter portion, an inner ring (8) slidably fit over the reduced diameter portion of the spindle shaft, a plurality of balls (14) interposed between a raceway (7) formed on the outer peripheral surface of the inner ring and a raceway (12) formed on the inner surface of the sleeve, and a plurality of balls interposed between a raceway (6) formed on the outer peripheral surface of the larger diameter portion of the spindle shaft and a raceway (11) formed on the inner peripheral surface of the sleeve, wherein the bearing is completed as the compound bearing by fixedly adhering the inner ring on the reduced diameter portion of the spindle shaft with applying onto balls an appropriate pre-load through the inner ring (8), and wherein the motor with the compound bearing is provided by connecting the sleeve (10) or the spindle shaft (5) of the compound ball bearing integrally with the hub constituting a rotor (9) or the base (2).

### BACKGROUND OF THE INVENTION

1. Technical Field

The present invention relates to a motor with a compound bearing for so called OA (Office Automation) device such as hard disk drive device or the peripheral device for computers.

2. Description of the Prior Art

A motor for example a spindle motor for the OA device includes a hub constituting a rotor, a base, a yoke holder, and a spindle shaft as shown in FIG. 7. The hub is rotatably journalled around the spindle shaft through a bearing apparatus including the spindle shaft, a pair of ball bearings having inner and outer rings, and a sleeve fit over outer rings of the ball bearings. Although in the structure as shown in FIG. 7, each of the sleeve and hub is formed as a one part respectively, each of the spindle shaft, ball bearings, and the sleeve forming the bearing apparatus is formed as an independent single element respectively.

As can be seen from the above, the motor of the prior art includes many parts, and the assembling operation of these parts should be made on the side of the manufacturer of the motor (motor maker) when the motor is manufactured. Such assembling operation requires many steps for fabricating the motor, and the cost for manufacturing the motor is relatively high.

Further, in the case of the motor of the prior art, the precision of the rotational run-out of the shaft should be compensated for during the fabrication of the motor. It is difficult to enhance the precision of the rotational run-out.

Additionally in the motor of the prior art, the size of the shaft is limited by the inner diameter of the inner rings, so that the diameter of the shaft should be reduced while miniaturizing the motor. When the diameter of the shaft is reduced, the rigidity and the strength of the shaft is reduced, and the resistance against impact or resonance is impaired.

Accordingly the object of the present invention is to provide a bearing apparatus as a completed product assembled in high precision on the side of the bearing manufacturer (bearing maker). On the side of the motor maker, it is only necessary to assemble the finished product with the motor, and the process for assembling the bearing apparatus is unnecessary. It is therefore possible to reduce the number of steps required for assembling the motor with the compound bearing. Thus obtained compound bearing is higher in its precision of the rotational run-out. The cost for manufacturing can be reduced. Further, the diameter of the shaft can be enlarged to provide the motor or the spindle motor of high resistance against impact or resonance.

### SUMMARY OF THE INVENTION

These and other objects are achieved by a motor with a compound bearing for OA device in accordance with the first embodiment of the present invention having a spindle shaft assembled within a sleeve of the bearing apparatus through balls, the bearing comprising; the spindle shaft formed of a stepped shaft including a reduced diameter portion and a larger diameter portion, an inner ring slidably fit over the reduced diameter portion of the spindle shaft, a plurality of balls interposed between a raceway formed on the outer peripheral surface of the inner ring and a raceway formed on the inner surface of the sleeve, and a plurality of balls interposed between a raceway formed on the outer peripheral surface of the larger diameter portion of the spindle shaft and a raceway formed on the inner peripheral surface of the sleeve, wherein the bearing is completed as the compound bearing by fixedly adhering the inner ring on the reduced diameter portion of the spindle shaft with applying onto balls an appropriate pre-load through the inner ring, and wherein the motor with the compound bearing is provided by connecting the sleeve of the compound ball bearing integrally with the hub constituting the rotor.

A motor with a compound bearing for OA device in accordance with the second embodiment having a spindle shaft assembled within a sleeve of the bearing apparatus through balls, the bearing comprising; the spindle shaft formed of a stepped shaft including a reduced diameter portion and a larger diameter portion, an inner ring slidably fit over the reduced diameter portion of the spindle shaft, a plurality of balls interposed between a raceway formed on the outer peripheral surface of the inner ring and a raceway formed on the inner surface of the sleeve, and a plurality of balls interposed between a raceway formed on the outer peripheral surface of the larger diameter portion of the spindle shaft and a raceway formed on the inner peripheral surface of the sleeve, wherein the bearing is completed as the compound bearing by fixedly adhering the inner ring on the reduced diameter portion of the spindle shaft with applying onto balls an appropriate pre-load through the inner ring, and wherein the motor with the compound bearing is provided by connecting the spindle shaft of the compound ball bearing integrally with the hub constituting the rotor.

A motor with a compound bearing for OA device in accordance with the third embodiment having a spindle shaft assembled within a sleeve of the bearing apparatus through balls, the bearing comprising; the spindle shaft formed of a stepped shaft including a reduced diameter portion and a larger diameter portion, an inner ring slidably fit over the reduced diameter portion of the spindle shaft, a plurality of balls interposed between a raceway formed on the outer peripheral surface of the inner ring and a raceway formed on the inner surface of the sleeve, and a plurality of balls interposed between a raceway formed on the outer peripheral surface of the larger diameter portion of the spindle shaft and a raceway formed on the inner peripheral surface of the sleeve, wherein the bearing is completed as the compound bearing by fixedly adhering the inner ring on the reduced diameter portion of the spindle shaft with applying onto balls an appropriate pre-load through the inner ring, and wherein the motor with the compound bearing is provided by connecting the sleeve of the compound ball bearing integrally with the base.

A motor with a compound bearing for OA device in accordance with the fourth embodiment having a spindle shaft assembled within a sleeve of the bearing apparatus through balls, the bearing comprising; the spindle shaft formed of a stepped shaft including a reduced diameter portion and a larger diameter portion, an inner ring slidably fit over the reduced diameter portion of the spindle shaft, a plurality of balls interposed between a raceway formed on the outer peripheral surface of the inner ring and a raceway formed on the inner surface of the sleeve, and a plurality of balls interposed between a raceway formed on the outer peripheral surface of the larger diameter portion of the spindle shaft and a raceway formed on the inner peripheral surface of the sleeve, wherein the bearing is completed as the compound bearing by fixedly adhering the inner ring on the reduced diameter portion of the spindle shaft with applying onto balls an appropriate pre-load through the inner ring, and wherein the motor with the compound bearing is provided by connecting the sleeve of the compound ball bearing integrally with the base formed integrally with a stator yoke holder.

A motor with a compound bearing for OA device in accordance with the fifth embodiment having a spindle shaft assembled within a sleeve of the bearing apparatus through balls, the bearing comprising; the spindle shaft formed of a stepped shaft including a reduced diameter portion and a larger diameter portion, an inner ring slidably fit over the reduced diameter portion of the spindle shaft, a plurality of balls interposed between a raceway formed on the outer peripheral surface of the inner ring and a raceway formed on the inner surface of the sleeve, and a plurality of balls interposed between a raceway formed on the outer peripheral surface of the larger diameter portion of the spindle shaft and a raceway formed on the inner peripheral surface of the sleeve, wherein the bearing is completed as the compound bearing by fixedly adhering the inner ring on the reduced diameter portion of the spindle shaft with applying onto balls an appropriate pre-load through the inner ring, and wherein the motor with the compound bearing is provided by connecting the spindle shaft of the compound ball bearing integrally with the base.

### BRIEF DESCRIPTION OF THE DRAWINGS

Further features of the present invention will become apparent to those skilled in the art to which the present invention relates from reading the following specification with reference to the accompanying drawings, in which:

FIG. 1 is a vertical cross sectional view showing the first embodiment of the present invention;

FIG. 2 is a vertical cross sectional view showing the second embodiment of the present invention;

FIG. 3 is a vertical cross sectional view showing the third embodiment of the present invention;

FIG. 4 is a vertical cross sectional view showing the fourth embodiment of the present invention;

FIG. 5 is a vertical cross sectional view showing the fifth embodiment of the present invention;

FIG. 6 is a vertical cross sectional view showing the sixth embodiment of the present invention;

FIG. 7 is a partially broken elevational view showing the spindle motor of the prior art.

### DETAILED DESCRIPTION OF THE EMBODIMENTS OF THE PRESENT INVENTION

Embodiments of a motor with a compound bearing for OA devices in accordance with the present invention will now be described with reference to the attached drawings.

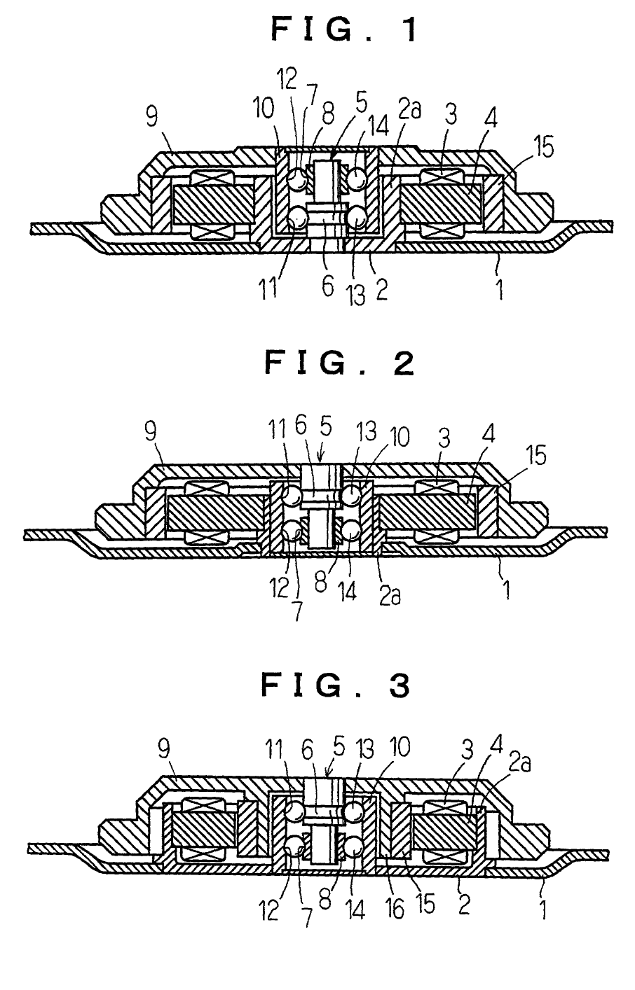

Shown in FIGS. 1 and 2 are spindle motors of outer rotor type in accordance with the present invention.

As shown in FIG. 1, a base 2 having a flange 1 is connected integrally with a cylindrical yoke holder 2a of the same material. A stator yoke 4 including coils 3 is provided around the yoke holder 2a.

A lower end of a spindle shaft 5 of the finished compound ball bearing mentioned herein below is secured on the center of the base 2. A sleeve 10 of the compound ball bearing is connected on a lower surface of a hub 9 constituting a rotor of the motor at the central portion thereof. The hub and the sleeve are connected integrally with each other. The hub is rotatably journalled through the compound ball bearing around the spindle shaft.

The spindle shaft 5 of the compound ball bearing is a stepped shaft including a reduced diameter portion and a larger diameter portion. The larger diameter portion includes a raceway 6 formed directly thereon. An inner ring 8 having a raceway 7 formed over the outer periphery thereof is fit around the reduced diameter portion.

A pair of parallel raceways 11 and 12 is formed on the inner surface of the sleeve 10 of the compound ball bearing. Each of these raceways corresponds with the raceway 6 formed on the larger diameter portion of the spindle shaft and the raceway 7 formed on the inner ring respectively. Balls 13 are interposed between the raceway 6 and the raceway 11, and balls 14 are interposed between the raceway 7 and the raceway 12.

When fabricated the above mentioned compound ball bearing in the bearing maker, the inner ring 8 is fit slidably over the reduced diameter portion of the spindle shaft 5, and the inner ring is fixedly adhered on the reduced diameter portion with applying an appropriate pre-load onto balls 13 and 14 through the inner ring. The compound ball bearing is adapted to be provided by the bearing maker as a finished product fabricated in high precision and an appropriate pre-load is applied.

The part to which reference numeral 15 is added is a magnet or magnets provided on the inner surface of the outer periphery of the hub so as to correspond with said yoke.

In the compound ball bearing in accordance with the second embodiment, the sleeve 10 is connected through the cylindrical stator yoke holder 2a to the central portion of the flange 1. The spindle shaft 5 is connected integrally with the lower surface of the hub 9 at the central portion thereof. The compound ball bearing of this embodiment has an upside down structure with respect to that shown in FIG. 1 so that relative structural relationship between the raceway 6 of the spindle shaft, the inner ring 8 and its raceway 7, the raceways 11 and 12 formed on the sleeve, and balls 13 and 14 are the same as that of FIG. 1.

In the second embodiment, the stator yoke 4 is mounted around said sleeve 10 through the stator yoke holder 2a.

While a motor is often required that the shaft thereof be made of a metallic material of high rigidity to prevent the rotational run-out from occurring, and the hub be made of a light metal of low inertia such as aluminum.

For example, the hub 9 is employed as a disk supporting plate of the hard disk drive device, the embodiment of FIG. 2 will satisfy the above mentioned demand.

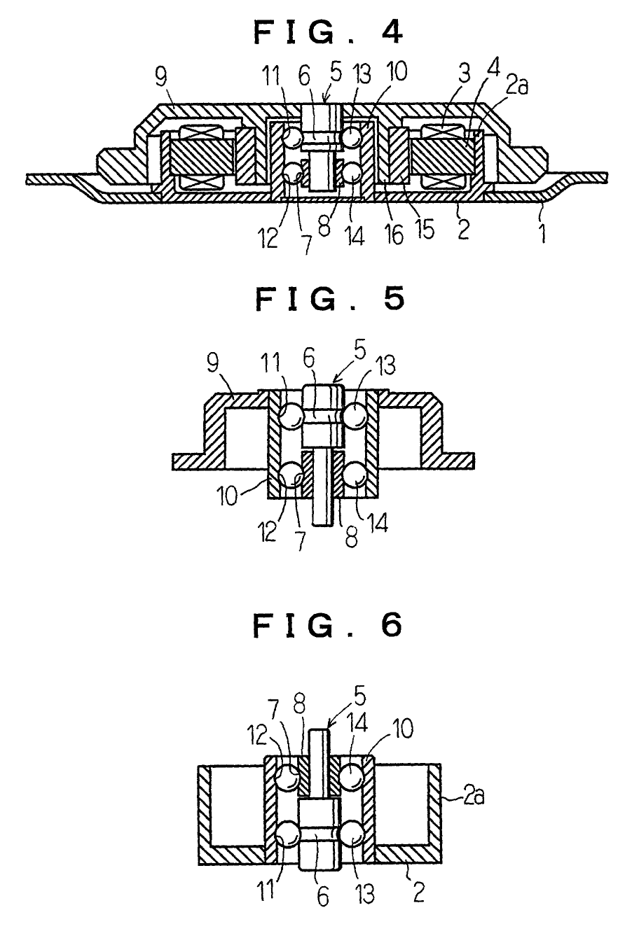

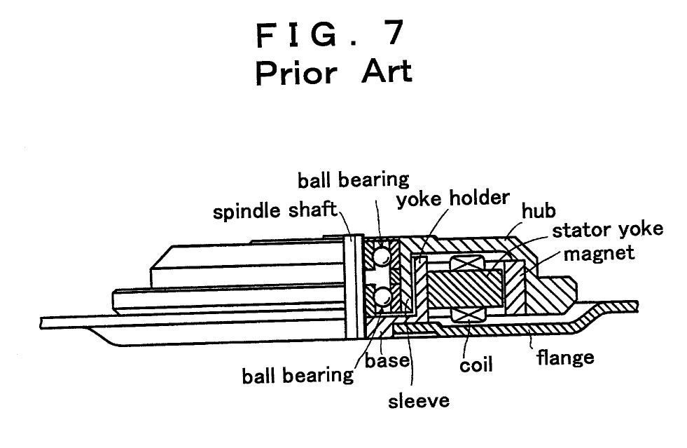

Spindle motors of inner rotor type will now be described with reference to FIGS. 3 and 4.

The motor of FIG. 3, the spindle shaft 5 of stepped shaft configuration is secured on the central portion of the bottom of the base 2 including the flange 1 around the outer periphery thereof, and the stator yoke 4 is provided on the inner surface of the stator yoke holder 2a.

In the motor of this embodiment, the hub 9 has at the lower surface thereof of the central portion a magnet holder 16 of the same material of the hub. A magnet or magnets are provided around the outer periphery of the magnet holder 16. The sleeve 10 of the compound ball bearing is fit into the holder 16 to connect the hub and the sleeve with each other. The structure of the compound ball bearing itself is the same as that of FIG. 1.

The motor of FIG. 4, the sleeve 10 of the compound ball bearing is integrally connected with the base 2 including the stator yoke holder 2a, the spindle shaft 5 is integrally connected with the hub 9, the stator yoke 4 is secured on the inner peripheral surface of the stator yoke holder 2a, and a magnet or magnets are provided around the outer periphery of the magnet holder 16 formed on the lower surface of the hub 9 at the central portion thereof by the same material as that of the hub.

A stepped shaft is used as the spindle shaft, and the structure of the compound ball bearing itself is the same as that of FIG. 2.

The motor of this embodiment is also suitable for the hard disk drive apparatus. Provided that the hub is used as a disk supporting plate, although the shaft is made of a metallic material of high rigidity, and the hub is made of a light metal of low inertia such as aluminum.

In the above mentioned embodiments, the inner surface (upper surface) of the flange is provided with a printed circuit board (not shown) corresponding to the coil 3 for driving a motor.

A variety of alternative embodiments in which the hub and/or base are connected with the sleeve and/or the spindle shaft of the compound ball bearing can be made. One of these alternative embodiments is described below in summary.

The structure shown in FIG. 5 has substantially the same structure as those illustrated in FIGS. 1 and 3 in which the sleeve 10 of the compound ball bearing is connected integrally with the hub 9. However, the compound ball bearing is set upside down relative to those shown in FIGS. 1 and 3.

The structure shown in FIG. 6 has substantially the same structure as that illustrated in FIG. 4 in which the sleeve 10 of the compound ball bearing is connected integrally with the base 2. However, the compound ball bearing is set upside down relative to that shown in FIG. 4.

The method for connecting the component parts with each other is varied depending on the structure of the motor. These connecting methods include a fit and bond under pressure method, an adhesion, welding, and so on.

### THE EFFECT AND ADVANTAGES OF THE PRESENT INVENTION

In the structure of the present invention, the component parts of the compound ball bearing such as the sleeve as well as the spindle shaft and the inner ring are adapted to be connected integrally with the hub constituting a rotor and/or the base, so that the motor assembling operation can be made easily on the side of the motor maker, the assembling operation can be made efficiently by machine, the manufacturing cost can be reduced. There are the substantial advantages over the prior art.

The embodiment claimed in claims 2 and 5, the necessity of the centering process for centering the spindle shaft with respect to the hub or the base to be carried out on the side of the motor maker is obviated, since the spindle shaft of the compound ball bearing is already connected integrally with the hub or the base. The motor of high rotational precision and has no rotational run-out can thus be obtained thereby.

The spindle shaft of the compound ball bearing has the raceway formed directly on its larger diameter portion, so that there is no need for mounting an inner ring on the larger diameter portion. In this connection the diameter of the larger diameter portion of the spindle shaft is large enough to enhance the rigidity and the strength of the spindle shaft. The motor improved substantially in its resistance against impact and resonance can thus be realized.

In accordance with the present invention, the number of parts and the number of steps for assembling the parts can be reduced, since the sleeve of the compound ball bearing can be employed as an outer ring used commonly for a pair of ball bearings, and no inner ring is required on the larger diameter portion of the spindle shaft.

In manufacturing the motor for hard disk drive apparatus, it is necessary to form the parts such as the hub and the base by the non-magnetic and light weight (low inertia) material such as aluminum. Whereas the material of high rigidity and strength such as hardened ball bearing steel is used on the spindle shaft or the sleeve. In accordance with the present invention, the hub and the base can be formed by a different material from that used in the spindle shaft or the sleeve, since the motor has a structure in which the hub or the base are adapted to be connected integrally with spindle shaft or the sleeve. This will lead to the enhancement the range of the application of the present invention.

While particular embodiments of the present invention have been illustrated and described, it should be obvious to those skilled in the art that various changes and modifications can be made without departing from the spirit and scope of the invention.

What is claimed is:

1. A motor with a compound bearing for OA device having a spindle shaft assembled within a sleeve of the bearing apparatus through balls,
the bearing comprising;
the spindle shaft formed of a stepped shaft including a reduced diameter portion and a larger diameter portion,
an inner ring slidably fit over the reduced diameter portion of the spindle shaft,
a plurality of balls interposed between a raceway formed on the outer peripheral surface of the inner ring and a raceway formed on the inner surface of the sleeve, and
a plurality of balls interposed between a raceway formed on the outer peripheral surface of the larger diameter portion of the spindle shaft and a raceway formed on the inner peripheral surface of the sleeve,
wherein the bearing is completed as the compound bearing by fixedly adhering the inner ring on the reduced diameter portion of the spindle shaft with applying onto balls an appropriate pre-load through the inner ring, and
wherein the motor with the compound bearing is provided by connecting the sleeve of the compound ball bearing integrally with the hub constituting a rotor.

2. A motor with a compound bearing for OA device having a spindle shaft assembled within a sleeve of the bearing apparatus through balls,
the bearing comprising;
the spindle shaft formed of a stepped shaft including a reduced diameter portion and a larger diameter portion,
an inner ring slidably fit over the reduced diameter portion of the spindle shaft,
a plurality of balls interposed between a raceway formed on the outer peripheral surface of the inner ring and a raceway formed on the inner surface of the sleeve, and
a plurality of balls interposed between a raceway formed on the outer peripheral surface of the larger diameter portion of the spindle shaft and a raceway formed on the inner peripheral surface of the sleeve,
wherein the bearing is completed as the compound bearing by fixedly adhering the inner ring on the reduced diameter portion of the spindle shaft with applying onto balls an appropriate pre-load through the inner ring, and
wherein the motor with the compound bearing is provided by connecting the spindle shaft of the compound ball bearing integrally with the hub constituting a rotor.

3. A motor with a compound bearing for OA device having a spindle shaft assembled within a sleeve of the bearing apparatus through balls,
the bearing comprising;
the spindle shaft formed of a stepped shaft including a reduced diameter portion and a larger diameter portion,
an inner ring slidably fit over the reduced diameter portion of the spindle shaft,
a plurality of balls interposed between a raceway formed on the outer peripheral surface of the inner ring and a raceway formed on the inner surface of the sleeve, and
a plurality of balls interposed between a raceway formed on the outer peripheral surface of the larger diameter portion of the spindle shaft and a raceway formed on the inner peripheral surface of the sleeve,
wherein the bearing is completed as the compound bearing by fixedly adhering the inner ring on the reduced diameter portion of the spindle shaft with applying onto balls an appropriate pre-load through the inner ring, and
wherein the motor with the compound bearing is provided by connecting the sleeve of the compound ball bearing integrally with the base.

4. A motor with a compound bearing for OA device having a spindle shaft assembled within a sleeve of the bearing apparatus through balls,
the bearing comprising;
the spindle shaft formed of a stepped shaft including a reduced diameter portion and a larger diameter portion,
an inner ring slidably fit over the reduced diameter portion of the spindle shaft,
a plurality of balls interposed between a raceway formed on the outer peripheral surface of the inner ring and a raceway formed on the inner surface of the sleeve, and
a plurality of balls interposed between a raceway formed on the outer peripheral surface of the larger diameter portion of the spindle shaft and a raceway formed on the inner peripheral surface of the sleeve,
wherein the bearing is completed as the compound bearing by fixedly adhering the inner ring on the reduced diameter portion of the spindle shaft with applying onto balls an appropriate pre-load through the inner ring, and
wherein the motor with the compound bearing is provided by connecting the sleeve of the compound ball bearing integrally with the base formed integrally with a stator yoke holder.

5. A motor with a compound bearing for OA device having a spindle shaft assembled within a sleeve of the bearing apparatus through balls,
the bearing comprising;
the spindle shaft formed of a stepped shaft including a reduced diameter portion and a larger diameter portion,
an inner ring slidably fit over the reduced diameter portion of the spindle shaft,
a plurality of balls interposed between a raceway formed on the outer peripheral surface of the inner ring and a raceway formed on the inner surface of the sleeve, and
a plurality of balls interposed between a raceway formed on the outer peripheral surface of the larger diameter portion of the spindle shaft and a raceway formed on the inner peripheral surface of the sleeve,
wherein the bearing is completed as the compound bearing by fixedly adhering the inner ring on the reduced diameter portion of the spindle shaft with applying onto balls an appropriate pre-load through the inner ring, and
wherein the motor with the compound bearing is provided by connecting the spindle shaft of the compound ball bearing integrally with the base.
